(19) United States
(12) Patent Application Publication
(10) Pub. No.: US 2014/0008824 A1
(43) Pub. Date: Jan. 9, 2014

(54) Methods and Systems for Manufacturing Contact Lenses

(71) Applicants: Xuxian Niu, Pleasanton, CA (US); Ryszard Radwanski, Livemore, CA (US); Henry Sarja, Walnut Creek, CA (US); Eddie E. Baker, Atwater, CA (US); James R. Hufman, Columbia, CA (US); Roger R. Wenzel, Jarrell, TX (US); Theodore V. Meigs, Twain Harte, CA (US)

(72) Inventors: Xuxian Niu, Pleasanton, CA (US); Ryszard Radwanski, Livemore, CA (US); Henry Sarja, Walnut Creek, CA (US); Eddie E. Baker, Atwater, CA (US); James R. Hufman, Columbia, CA (US); Roger R. Wenzel, Jarrell, TX (US); Theodore V. Meigs, Twain Harte, CA (US)

(73) Assignee: COOPERVISION INTERNATIONAL HOLDING COMPANY, LP, St. Michael (BB)

(21) Appl. No.: 13/984,924

(22) PCT Filed: Jul. 19, 2012
(86) PCT No.: PCT/US12/47357

§ 371 Date: Aug. 12, 2013

Related U.S. Application Data
(60) Provisional application No. 61/512,797, filed on Jul. 28, 2011.

(51) Int. Cl. B29D 11/00

(52) U.S. Cl. CPC B29D 11/00259
USPC 264/1.1; 425/346

(57) ABSTRACT

A method and system for manufacturing a contact lens are disclosed involving aligning a male lens mold section and a female lens mold section. A picking head removes a male lens mold section from a male pallet for transfer to a female mold section on a female pallet. The picking head may move substantially freely in a plane perpendicular to the longitudinal axis of the picking head as the distance between the male and female mold sections decreases. Alignment, for example, substantially precise alignment between the male mold section, carried by the picking head, and the female mold section carried by the female pallet may be achieved before the male mold section comes in contact with the female mold section.

### CROSS-REFERENCE TO RELATED APPLICATIONS

The present application claims the benefit of U.S. Provisional Application Ser. No. 61/512,797, filed Jul. 28, 2011, the disclosures of which is incorporated in its entirety herein by reference.

### FIELD OF THE INVENTION

The invention relates to manufacturing contact lenses. More specifically, the invention relates to new methods and systems for manufacturing contact lenses.

### BACKGROUND OF THE INVENTION

Contact lenses are often fabricated using mold assemblies in which a male mold section and a female mold section come together to form a lens-shaped cavity between the mold sections.

Typically, a mold assembly for producing a single contact lens includes a female mold section having a concave optical surface defining an anterior surface of a lens to be made, and a male mold section having a convex optical surface defining a posterior surface of the lens to be made. When individual male and female mold sections are assembled together, a contact lens shaped cavity is formed between the concave surface of the female section and the convex surface of the male section.

A contact lens precursor composition, for example, a polymerizable composition including one or more monomers, is placed or deposited within the lens shaped cavity. For example, the polymerizable composition may be placed in contact with the concave surface of a female mold section and a male mold section is placed on the female mold section so that the convex surface of the male mold section contacts the polymerizable composition and maintains the polymerizable composition in the lens shaped cavity. The polymerizable composition may be polymerized in the mold assembly to form a polymeric lens body. The polymeric lens body is removed from the mold sections and is further treated and eventually packaged for consumer use as a contact lens.

The male and female mold sections used in the above-mentioned contact lens manufacturing process are themselves commonly formed through the use of molding processes, including injection molding and lathing. These mold sections may be formed from thermoplastic materials, for example, such as polystyrene, polypropylene, ethylene vinyl alcohol polymers, other vinyl alcohol copolymers, other thermoplastic polymeric materials, and the like.

In conventional contact lens manufacturing processes, the lack of precise alignment between the male and female molds forming the contact lens mold assembly has caused significant lens edge damage and disadvantageously high prism on edge thickness. In addition, a significant amount of the polymerizable composition, which may be quite expensive, is wasted from mold overflow and spilled onto other components if the mold sections are not properly aligned. This increases the costs of manufacturing contact lenses. Additionally, misalignment of the mold sections may cause the finished lenses to be scrapped. Even relatively small amounts of misalignment between the mold sections can result in some lens edge damage and high prism on edge thickness and cause discomfort to the lens wearer.

It would be advantageous to provide new methods and systems for manufacturing contact lenses which address one or more of these and other concerns.

### SUMMARY OF THE INVENTION

New methods and systems for manufacturing contact lens have been discovered which provide alignment, for example, precise alignment, such as perfect or substantially perfect alignment, of the male mold section and the female mold section forming a contact lens mold assembly in which a contact lens can be formed in the lens-shaped cavity formed between the male mold section and the female mold section. Having the male mold section and female mold section so aligned in the mold assembly, for example, precisely aligned, can provide substantial improvements relative to using a mold assembly with misaligned male and female mold sections. Such improvements can include, without limitation, reduced contact lens manufacturing costs, reduced lens edge damage, a reduced incidence of unacceptable prism, and the manufacture of contact lenses which are more comfortable to wear. The present methods and systems are highly adaptable to manufacturing large numbers of contact lenses using male and female mold sections which are aligned, for example, precisely or substantially precisely aligned in the mold assembly. The present methods and system can be used to manufacture a large number of contact lenses, for example, at least about 100, about 500 or about 1000 or more lenses. In one example, when the present invention is used to manufacture a large number of contact lenses, the yield or percentage of acceptable contact lenses manufactured in accordance with the present invention can be higher than for identical contact lenses manufactured in identical mold assemblies without the male and female mold sections of the mold assembly being aligned in accordance with the present invention.

The present invention provides a method for manufacturing a contact lens which comprises placing a picking head assembly comprising a picking head and a plurality of spaced apart alignment pins into engagement with a first pallet carrying or holding a male lens mold section and having a plurality of first holes sized and positioned to receive the plurality of spaced apart alignment pins. The placing step is effective so that the picking head comes into alignment with the male lens mold section as the plurality of spaced apart alignment pins are received by the plurality of first holes and before the picking head contacts the male lens mold section. The male lens mold section is then secured to the picking head. The picking head assembly and the secured male lens mold section are separated from the first pallet, and the separated picking head assembly and secured male lens mold section are moved into engagement with a second pallet carrying or holding a female lens mold section and having a plurality of second holes sized and positioned to receive the plurality of spaced apart alignment pins. The moving is effective so that the male lens mold section comes into alignment with the female lens mold section as the plurality of spaced apart alignment pins are received in the plurality of second holes and before the male lens mold section contacts the female lens mold section. The aligned male and female lens mold sections may then be placed in contact with each other.

The picking head has a longitudinal axis and the picking head assembly may move substantially freely in a plane perpendicular to the longitudinal axis of the picking head. The picking head may come into alignment with the male lens mold section without the picking head physically touching the male lens mold section.

The movement of the picking head assembly substantially freely in a plane perpendicular to the longitudinal axis of the picking head facilitates at least one of the coming into alignment of the picking head with the male lens mold section and the coming into alignment of the male lens mold section and the female lens mold section.

The plurality of alignment pins on the picking head assembly may be received into a plurality of first holes, e.g., alignment holes, in the first pallet to provide alignment between the picking head and the male lens mold section.

In one example, the male lens mold section includes a first optical surface, for example, a generally convex optical surface, and the female lens mold section includes a second optical surface, for example, a generally concave optical surface, and the moving step is effective so that the male lens mold section comes into alignment with the female lens mold section without the first optical surface contacting the second optical surface.

The present method involves the use of male (first) and female (second) pallets configured to carry or hold male and female molds, respectively.

The first or male pallet, the second or female pallet and the picking head assembly may be configured so the optical surface, for example, the optical convex surface, of the male lens mold section does not come into contact with any surface, for example, with any hard surface that may damage the optical surface of the male lens mold, when the first pallet is carrying or holding the male lens mold section, or when the male lens mold section is secured to the picking head, or during the separating of the male lens mold section from the first pallet, or during the moving the separated male lens mold section into engagement with the second pallet carrying or holding the female lens mold section, or during the closing of the aligned male and female lens mold sections together.

In one example, the first pallet carries or holds a plurality of male lens mold sections, and/or the second pallet holds or carries a plurality of female lens mold sections.

In one example, the male mold sections may be formed by direct injection of material into individual cavities, such that each mold section can be attached to its own separate runner system.

In one example, a plurality of male molds are arranged to form a male mold flower, for example, comprising the male mold sections, elongated runners or gates (spokes) and a central hub. The mold sections and runners may be located in substantially a single plane, for example forming a substantially planar array of male mold sections and runners. The arrangement of the mold sections in the flower can be “balanced”, meaning the length of the runners from the central hub to a mold section is about the same for all of the mold sections in the flower. Alternatively, the arrangement of the mold sections in the flower can be “unbalanced”, meaning the length of the runners from the central hub to a mold section is not about the same for all the mold sections in the flower. A stem or sprue may be provided perpendicular to the substantially single plane in which the mold sections and runners of the flower are located.

A female mold flower comprising a plurality of female mold sections, elongated runners, and a central hub arranged similarly to that described herein with regard to the male mold flower may be provided.

The pallets may include alignment features to prevent optical surface damage and to guide the mold flowers into position. Alignment features may comprise structural segments (for example, raised segments) that form a defined pathway for placement of the elongated runners to facilitate locating of the mold flowers onto the pallets. Both male and female pallets may comprise alignment holes into which a plurality of elongated, spaced apart alignment pins of the picking head assembly may be inserted.

The first pallet may include at least one first structural feature to facilitate the picking head coming into alignment with the male lens mold section. The second pallet may include at least one second structural feature to facilitate the male lens mold section, which may be carried by the picking head, coming into alignment with the female lens mold section.

The first pallet may have a cavity sized and positioned to receive the male lens mold section. The first pallet may have a rim, for example, a circumferential rim, recessed within and partially defining the cavity, the rim being adjacent, or substantially adjacent, the plurality of first holes sized and positioned to receive the plurality of spaced apart alignment pins, and being effective to assist in alignment of the male lens mold section in the cavity of the first pallet without contacting the optical surface of the male lens mold section.

In one example, the male lens mold section is attached to a first elongated runner and the first pallet includes a plurality of spaced apart first raised segments forming a defined pathway for placement of the first elongated runner to facilitate locating the male lens mold section on the first pallet, for example, as desired.

The male lens mold section may be one of a plurality of male lens mold sections, each male lens mold section being attached to a different first elongated runner and the first elongated runners being secured to a central hub, and the first pallet including a plurality of spaced apart first raised segments forming a plurality of defined pathways for placement of each of the elongated runners in a different defined pathway to facilitate locating the male lens mold sections on the first pallet, for example, as desired.

The first pallet may comprise one or more openings to allow the elongated runner or runners to pass through the first pallet when the elongated runner or runners is/are detached from the male lens mold section(s).

In one example, the method comprises detaching the first elongated runner from the male lens mold section prior to the step of placing the picking head assembly into engagement with the first pallet carrying or holding the male lens mold section. In one example, the method comprises detaching a plurality of elongated runners from a plurality of male lens mold sections prior to the step of placing the picking head assembly into engagement with the first pallet carrying or holding a plurality of male lens mold sections.

The second or female pallet may have a cavity sized and positioned to receive at least a portion of the female lens mold section. The second pallet may have a raised portion, for example, a circumferential raised portion, within the cavity sized and positioned to be effective in supporting the female mold section on the second pallet, and being effective in assisting in aligning the female lens mold section with the male mold section.

The female lens mold section may be attached to a second elongated runner and the second pallet may include a plurality of spaced apart second raised segments forming a defined pathway for placement of the second elongated runner to facilitate locating the female lens mold section on the second pallet, for example, as desired.

In one example, the female lens mold section is one of a plurality of female lens mold sections, each female lens mold section being attached to a different second elongated runner and the second elongated runners being secured to a second central hub, and the second pallet including plurality of spaced apart second raised segments forming plurality of defined pathways for placement of each of the second elongated runners in a different defined pathway to facilitate locating the female lens mold sections on the second pallet.

In one example, the female lens mold section includes a mold outside skirt, and the moving step is effective to contact the plurality of spaced apart alignment pins with the mold outside skirt prior to the plurality of spaced apart alignment pins being received by the plurality of second holes.

In one example, the securing step and/or the separating step comprises applying a vacuum or suction, for example, through a vacuum or suction system connected to the picking head assembly. After separating, the male lens mold section may be held to the picking head, for example, by vacuum or suction.

A polymerizable composition may be provided by a step comprising placing the polymerizable composition on the female lens mold section at one or more of the following times: before, during, or after the moving step.

After placing the aligned molds in contact with each other, a contact lens may be formed in a lens-shaped cavity between the male and female mold sections, i.e., in a mold assembly. The lens can be formed with the mold sections contacting each other only in their flanged regions and without the optical surfaces of the male and female mold sections touching or contacting each other.

A system for manufacturing a contact lens is also provided. In general, the system comprises a picking head assembly comprising a picking head and a plurality of spaced apart alignment pins; a first pallet carrying a male lens mold section and having a plurality of first holes sized and positioned to receive the plurality of spaced apart alignment pins; a vacuum source operatively coupled to the picking head and being operable to secure the male lens mold section to the picking head; and a second pallet carrying a female lens mold section and having a plurality of second holes sized and positioned to receive the plurality of spaced apart alignment pins. The picking head assembly and secured male lens mold section are movable into engagement with the second pallet so that the male lens mold section comes into alignment with the female lens mold section as the plurality of spaced apart alignment pins are received in plurality of second holes.

The system may further comprise a polymerizable composition on the female lens mold section, for example, a polymerizable composition present between the male lens mold section and the female lens mold section.

The present systems may be structured or adapted to be useful in carrying out the methods of manufacturing a contact lens, for example, as described herein. Much of the disclosure set forth herein applies to both such systems and methods.

In one example, the first pallet includes at least one first structural feature to facilitate the picking head coming into alignment with the male lens mold section. In one example, the second pallet includes at least one second structural feature to facilitate the male lens mold section, which may be carried by the picking head through vacuum suction, coming into alignment with the female lens mold section.

In one example, the picking head assembly and the first pallet are sized and structured so that the picking head comes into alignment with the male lens mold section carried by the first pallet without the picking head physically touching the male lens mold section.

In one example, the male lens mold section includes a first optical surface and the female lens mold section includes a second optical surface, and the system is sized and structured so that the male lens mold section secured to the picking head comes into alignment with the female lens mold section held by the second pallet without the first optical surface contacting the second optical surface.

In one example, the picking head has a longitudinal axis and the picking head assembly is substantially freely movable in a plane perpendicular to the longitudinal axis of the picking head.

The male pallet may comprise rims in cavities that receive the male molds.

The female pallet may comprise ridges in the cavities that receive and retain the female molds.

In one example, the female lens mold section may include a mold outside skirt. The female mold section may have a mold outside skirt that: (i) fits over a ridge in a cavity on a female pallet, for example, and is effective in assisting in aligning and/or stabilizing the female mold on the female pallet, and (ii) is effective in assisting in aligning the male mold section and the female mold section.

Before the male lens mold section is brought into contact with the female lens mold section on the female pallet, the plurality of spaced apart alignment pins of the picking head assembly carrying the male mold section are first received in holes in the female pallet. The holes in the female pallet are configured to receive the plurality of spaced apart pins of the picking head assembly.

In one example of the system, the male lens mold section and the female lens mold section may comprise a polymeric material, for example, a thermoplastic polymeric material, such as those materials commonly or conventionally used in contact lens mold sections. The thermoplastic polymeric material of the mold sections may comprise a polar thermoplastic polymeric material, such as, for example, an ethylene vinyl alcohol polymer or polybutylene terephthalate (PBT).

The first and second pallets may be made of any suitable material or combination of materials. In one example, the first and second pallets may comprise a polymeric material, for example, a thermoplastic polymeric material.

The mold sections and pallets may be made of compatible materials, for example, to facilitate the desired structure and functioning of the mold sections and pallets in accordance with the present invention. In one example, the male and female mold sections, may comprise the same material. The first pallet and the second pallet may comprise the same material.

In one example, lens bodies of the contact lenses manufactured according to the present invention are cast molded lens bodies that include an anterior surface and a posterior surface. The lens bodies may or may not be surface modified or treated. One or more of the surfaces of the lens bodies may be treated with plasma or subjected to other surface treatment or modification. The surfaces of the lens bodies may be free of plasma treatment or other surface treatment or modification.

The contact lenses manufactured according to the present invention may include a lens body, for example, comprising a soft or water swellable, e.g., hydrogel polymeric material. In one example, the lens body comprises a polymeric silicone hydrogel material.

In one example, the polymeric material comprises units from a silicon-containing monomer, for example, from at least one silicon-containing monomer, such as from two silicon-containing monomers having different molecular weights, and possibly different chemical structures.

In one example, the present contact lenses comprise only one silicon-containing monomer having a relatively high molecular weight, such as, for example, greater than 3,000 daltons, or greater than 5,000 daltons, or greater than 10,000 daltons. This example, that is the example comprising one silicon-containing monomer, may be particularly useful for daily wear silicone hydrogel contact lenses that are typically discarded (rather than cleaned) on a daily basis.

The contact lenses manufactured in accordance with the present invention may be in any suitable configuration effective to satisfy the needs of the lens wearer. For example, the present lenses may have a single refractive power or two or more refractive powers, such as a bifocal or multifocal lens, or may have no refractive power. The present lenses can provide spherical corrections, aspherical corrections, cylinder corrections, wave front corrections, corrections of aberrations and the like. Without limitation, examples of useful cylinder correction lenses which may be formed in accordance with the present invention are disclosed in Back U.S. Pat. No. 6,467,903, the disclosure of which is hereby incorporated in its entirety herein. The present lenses can be configured to be rotationally stabilized, for example, including ballasts, other rotationally stabilizing features and the like.

The present lenses may be untinted, tinted, colored, for example, with iris-simulating patterns, and the like. The present lenses may have any suitable edge geometries, such as rounded edges, for example, fully rounded edges from posterior face to anterior face, rounded edges which include portions of the anterior face or the posterior face of the lens and the like. Such rounded edges or edge portions may be useful in enhancing the comfort and safety of wearing the present contact lenses, particularly during extended wear of such contact lenses. Without limitation, examples of useful contact lenses with rounded edges which may be formed in accordance with the present invention are disclosed in U.S. Pat. No. 6,431,706, the disclosure of which is hereby incorporated in its entirety herein.

Each and every feature described herein, and each and every combination of two or more of such features, is included within the scope of the present invention provided that the features included in such a combination are not mutually inconsistent as will be apparent from the context, this specification, and the knowledge of one of ordinary skill in the art. In addition, any feature or combination of features may be specifically excluded from any example of the present invention.

These and other aspects and advantages of the present invention will become apparent in the following detailed description, drawings, examples and claims, particularly when considered in conjunction with the accompanying drawings in which like parts bear like reference numerals.

### BRIEF DESCRIPTION OF THE DRAWINGS

FIG. 1 is a perspective view showing a male mold flower about to be loaded on a first or male pallet.

FIG. 1A is a perspective view of an alternate male mold flower.

FIG. 1B is a perspective view of another male mold flower.

FIG. 1C is a perspective view of a further male mold flower.

FIG. 2 is a perspective view showing the male mold flower positioned on the first pallet.

FIG. 3 is a perspective view showing the individual male lens mold sections positioned on the first pallet after being de-gated.

FIG. 4 is a perspective view showing a female mold flower about to be loaded on a second or female pallet.

FIG. 5 is a perspective view showing the female mold flower loaded on the female pallet.

FIG. 6 is a perspective view showing a picking head of a picking head assembly approaching the first pallet.

FIG. 6A is a cross-sectional view of a portion of a picking head assembly.

FIG. 6B is a perspective view of a picking head assembly (with a housing component shown transparent for illustration clarity).

FIG. 7 is a perspective view showing the picking head being aligned precisely with the male mold section positioned on the first pallet.

FIG. 8 is a perspective view showing the picking head of the picking head assembly fully engaged with a male lens mold section on the first pallet.

FIG. 9 is a cross-sectional view showing the picking head of the picking head assembly fully engaged with a male lens mold section on the first pallet.

FIG. 10 is a perspective view showing the picking head assembly with the picking head carrying the male lens mold section that has been picked up and separated from the first pallet.

FIG. 11 is a perspective view showing the picking head assembly, carrying the male mold section carried by the picking head, and moving toward the second or female pallet.

FIG. 12 is a perspective view showing the picking head assembly carrying the male mold section approaching the female pallet to align the male mold section and the female mold section.

FIG. 13 is a cross-sectional view of the picking head assembly carrying the male mold section moving into engagement with the second or female pallet carrying the female mold section.

FIG. 14 is a perspective view showing the picking head assembly, carrying the male mold section, engaged with the female mold and alignment of the male mold section and the female mold section is completed without the optical surfaces of the male and female mold sections physically contacting each other.

FIG. 15 is a cross-sectional view of the picking head assembly moved away from the female mold section to allow for dosing of the polymerizable composition onto the female mold section.

FIG. 16 is a cross-sectional view of the picking head assembly and the male and female mold sections after dosing of the polymerizable composition.

FIG. 17 is a somewhat schematic illustration showing (A) a symmetrical flower of runners and mold sections with all opposite angles equal; and (B) an asymmetrical flower of runners and mold segments with at least 2 opposite angles unequal. Although labeled with the male reference numerals, these arrangements of equal (A) and unequal (B) angles could represent either the male or the female lens mold sections and associated runners.

### DETAILED DESCRIPTION OF THE INVENTION

### Definitions

In the context of the present description, drawings, and additional disclosure claims, the following terminology will be used in accordance with the definitions described below. Unless expressly stated to the contrary herein, a number of terms set forth herein have the same or substantially the same definition as the same or substantially the same term defined in U.S. patent application Ser. No. 12/894,941, filed Sep. 30, 2010, entitled “SILICONE HYDROGEL CONTACT LENSES AND METHODS OF MAKING SILICONE HYDROGEL CONTACT LENSES”, the disclosure of which in its entirety is incorporated herein by reference.

As used herein, the term “hydrogel” refers to polymeric material, typically a network or matrix of polymer chains, capable of swelling in water or becoming swollen with water. A hydrogel can also be understood to be a material that retains water in an equilibrium state. The network or matrix may or may not be cross-linked. Hydrogels refer to polymeric materials, including contact lenses that are water swellable or are water swelled. Thus, a hydrogel may be (i) unhydrated and water swellable, or (ii) partially hydrated and swollen with water, or (iii) fully hydrated and swollen with water. The hydrogel may be a silicone hydrogel, a silicone-free hydrogel, or an essentially silicone-free hydrogel.

A “hydrophilic” substance is one that is water-loving or has an affinity for water. Hydrophilic compounds have an affinity to water and are usually charged or have polar moieties or groups that attract water.

As used herein, the terms “male mold” and “female mold” are abbreviated versions of and interchangeable with the terms “male lens mold section” and “female lens mold section”, respectively.

A “monomer” refers to a single unit of a molecule containing one or more functional groups capable of polymerizing to combine with other molecules to form a polymer, the other molecules being of the same structure or different structures as the monomer. The monomer can be a relatively low molecular weight compound, for example a compound with a number average molecular weight less than 700 daltons. A monomer can also be a medium to high molecular weight compound, for example, a compound with a number average molecular weight of from about 700 daltons to about 2,000 daltons. A monomer can also be a high molecular weight compound, for example, a compound having a number average molecular weight greater than 2,000 daltons, such as, for example, greater than 5,000 daltons, or greater than 7,000 daltons.

A “polymer” refers to a material formed by polymerizing one or more monomers. As used herein, a polymer is understood to refer to a molecule that is not capable of being polymerized, but may be capable of being crosslinked to other polymers, for example, to other polymers present in a polymerizable composition or during the reaction of monomers to form other polymers in a polymerizable composition.

A “prepolymer” refers to a polymerizable or crosslinkable higher molecular weight compound. A prepolymer, as used herein can contain one or more functional groups. In one example, a prepolymer can be a series of monomers bonded together such that the overall molecule remains polymerizable or crosslinkable. For example, a prepolymer can be a compound with an average molecular weight greater than about 2,000 Daltons.

A “silicon-containing” component is a component that contains at least one silicon (Si) atom, for example, in a monomer or polymer. In addition to the silicon-containing compounds described herein, examples of still further silicon-containing components that may be useful in the present lenses can be found in U.S. Pat. Nos. 3,808,178, 4,120,570, 4,136,250, 4,139,513, 4,153,641, 4,740,533, 5,034,461, 5,496,871, 5,959,117, 5,998,498, and 5,981,675, and U.S. Patent Application Publication Nos. 20070066706 A1, 20070296914 A1, and 20080048350 A1, the disclosures of all of which are incorporated in their entireties herein by reference. The silicon-containing component can be a silicon-containing monomer a silicon-containing polymer.

A “siloxane-containing” component is a component that contains at least one unit of R₂SiO, where each R is independently either a hydrogen atom or a hydrocarbon group. Siloxane-containing components or siloxanes can have branched or linear backbones consisting of alternating silicon and oxygen atoms, i.e., —Si—O—Si—O, with side chains attached to the silicon atoms. The siloxane-containing component can be a monomer or polymer.

The term “silicone hydrogel” or “silicone hydrogel material” refers to a particular polymeric hydrogel that includes a silicon-containing component or a siloxane-containing component. For example, a silicone hydrogel is typically prepared by combining a silicon-containing material with conventional hydrophilic hydrogel precursors. A silicone hydrogel contact lens is a contact lens, including a vision correcting contact lens, which comprises a silicone hydrogel material.

### System and Method

The system of the present invention, for example, useful in the methods of manufacturing a contact lens, comprises the following elements: a picking head assembly having a picking head and a plurality of spaced apart alignment pins extending away, for example, downwardly, from the picking head, and a first or male pallet and a second or female pallet for carrying or holding at least one male mold section and at least one female lens mold section, respectively. In one example, the first pallet can be configured to carry or hold a single male mold section, and the second pallet can be configured to carry or hold a single female mold section. In another example, the first pallet can be configured to carry or hold a plurality of male mold sections, and the second pallet can be configured to carry or hold a plurality of female mold sections.

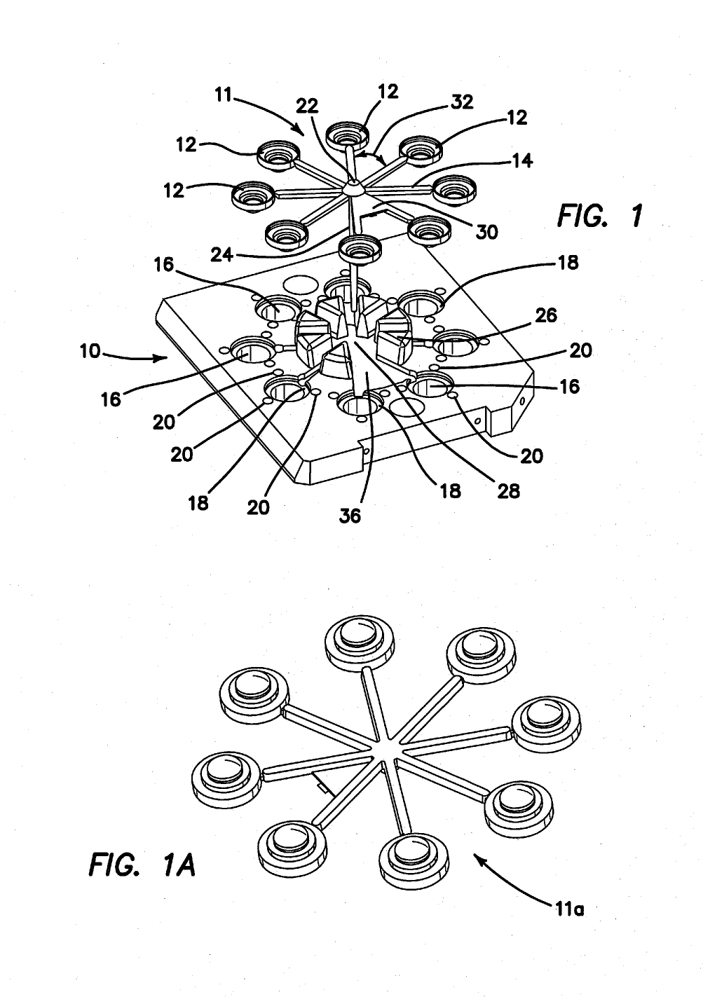

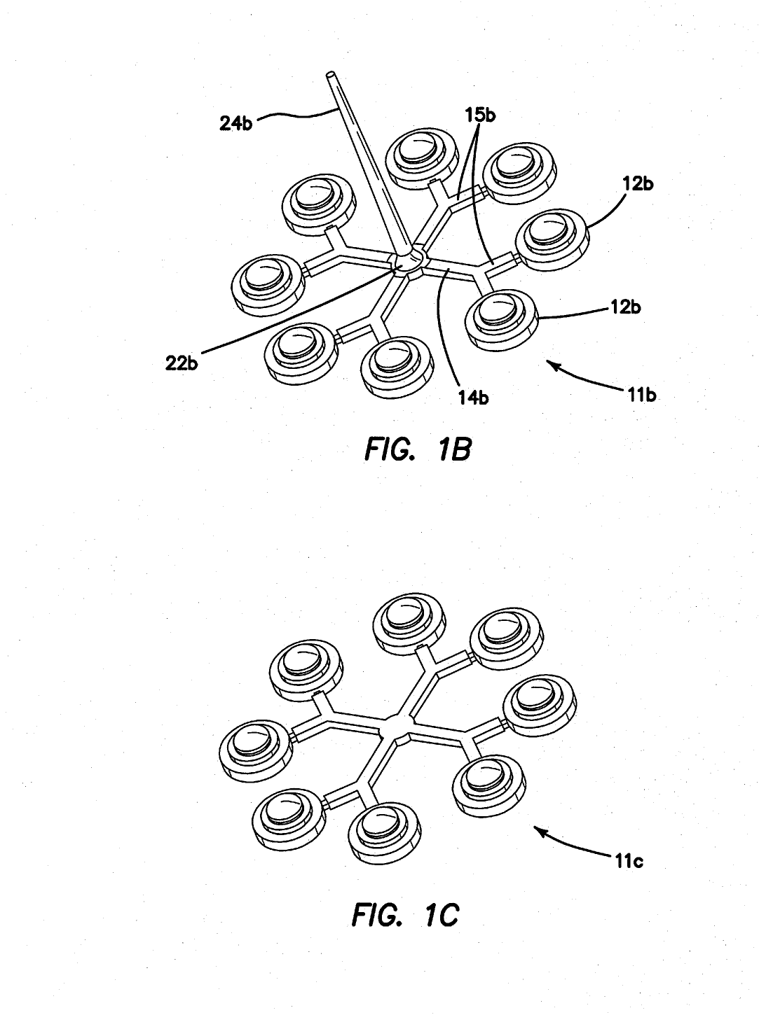

Referring now to FIG. 1, the first pallet 10 has cavities or depressions 16 therein structured or configured to receive male mold sections 12. As illustrated in FIG. 1, each of the cavities 16 can be partially defined by an inwardly extending circumferential rim 18 of the first pallet 10. The rims 18 can be sized and positioned to support the male mold sections 12 in the cavities 16. In one example, the rims 18 can be sized and positioned to support the male mold sections 12 in the cavities 16 such that an optical surface (i.e., a surface of the male mold section used to form the posterior section of a contact lens) does not contact the first pallet 10 when the male mold section 12 is being held or carried by the pallet 10. In one example, at least one cavity 16 or all of the cavities 16 may extend through the first pallet 10.

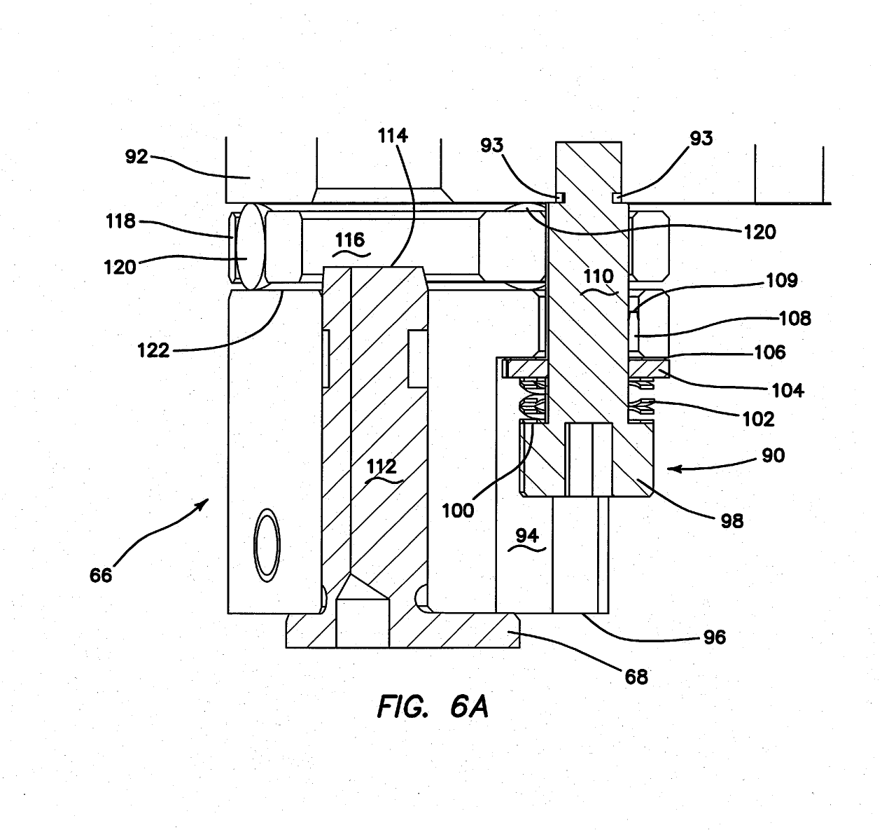

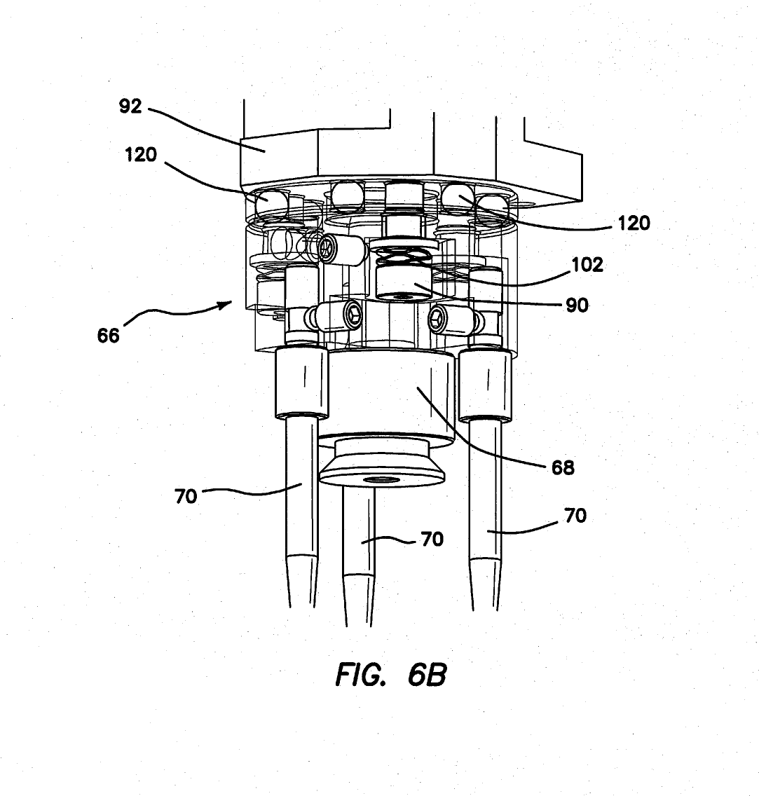

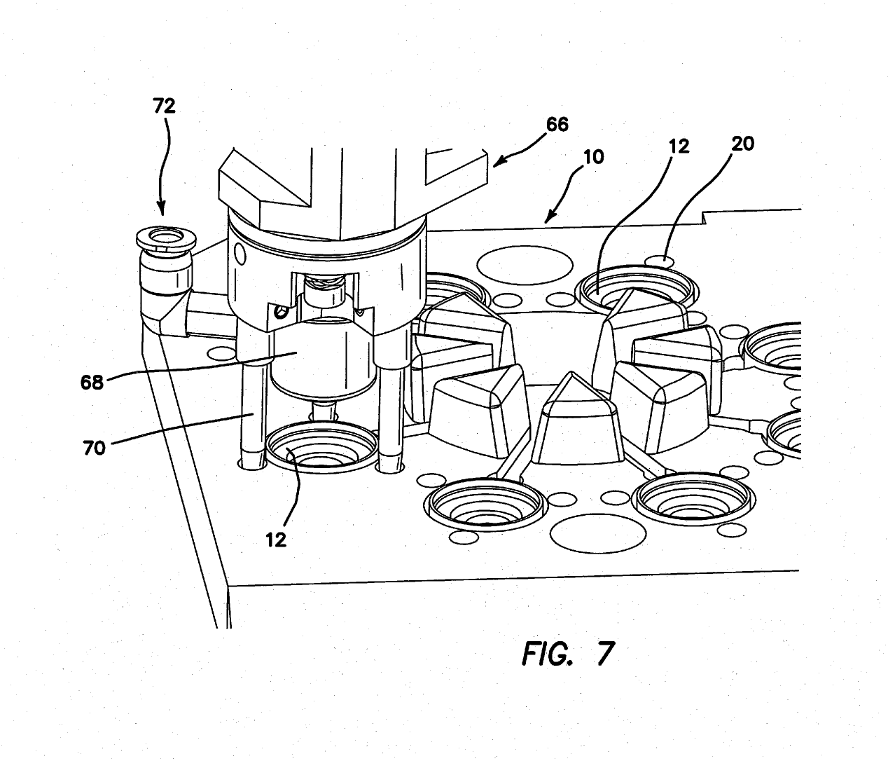

As illustrated in FIG. 1, each rim 18, partially defining each of the cavities 16, can be located substantially adjacent a plurality of spaced apart first alignment holes 20 in the first pallet 10 sized and positioned to receive the plurality of spaced apart alignment pins 70, as is described hereinafter (see discussion with regard to FIG. 6 and FIG. 7).

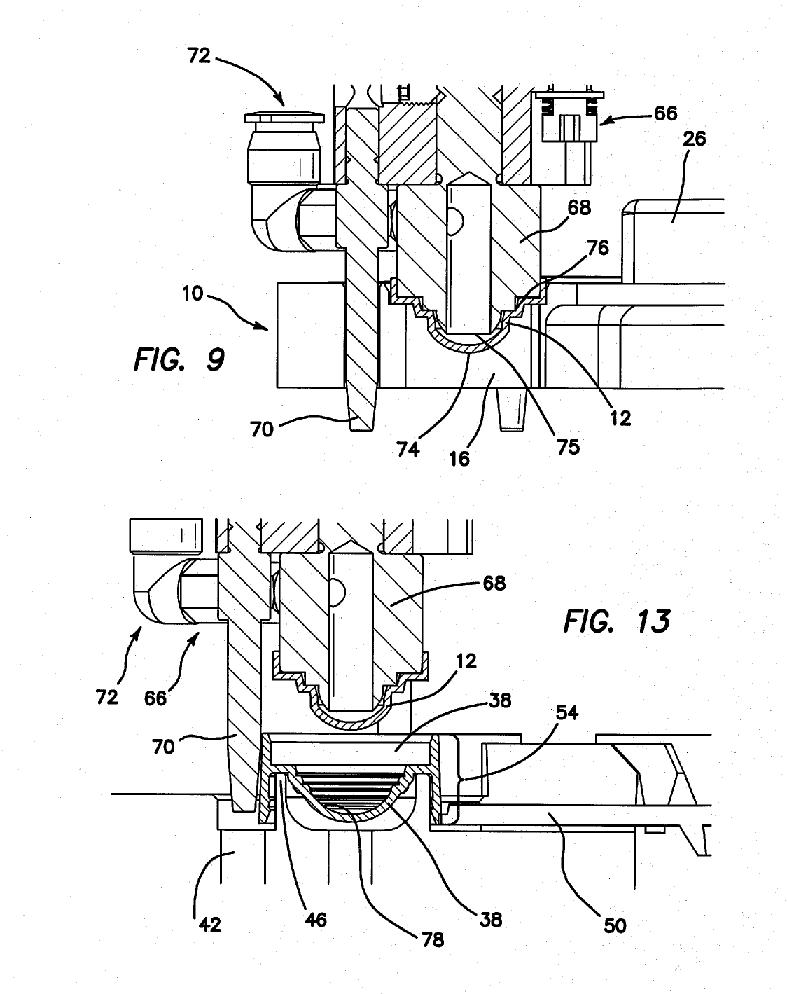

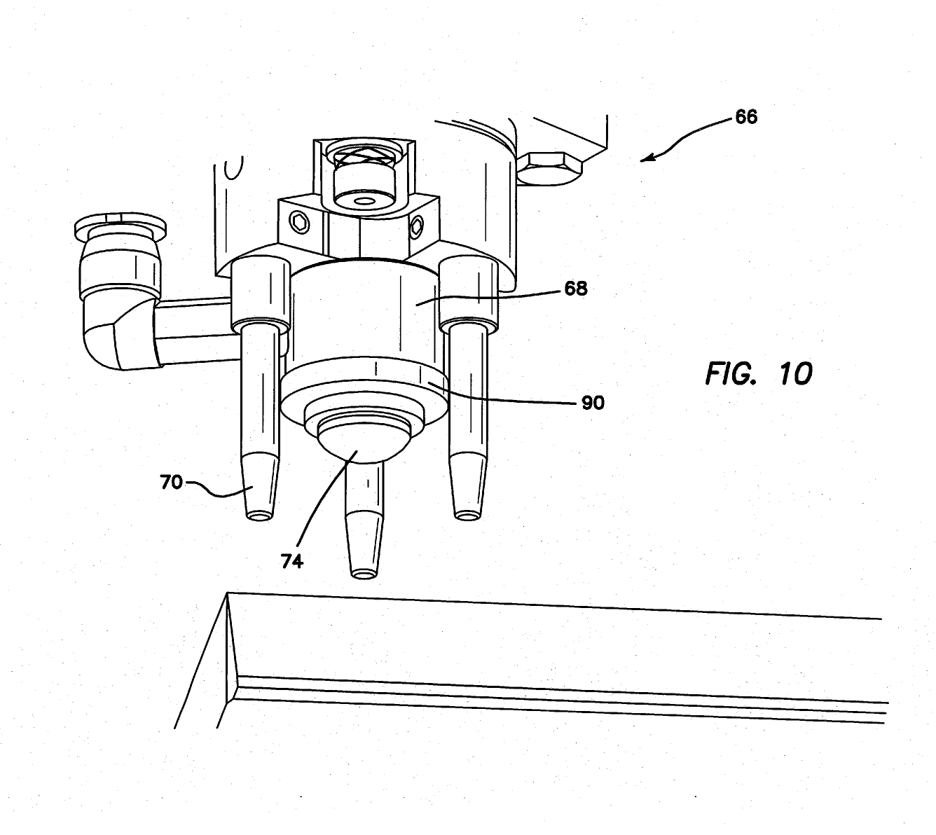

The first holes 20 are effective to assist or facilitate the alignment of the male mold section 12 in the cavity 16 without damaging the optical surface 74 (see FIG. 9 and FIG. 10) of the male mold 12 and without causing contact between the optical surface 74 of the male mold 12 and any other surface.

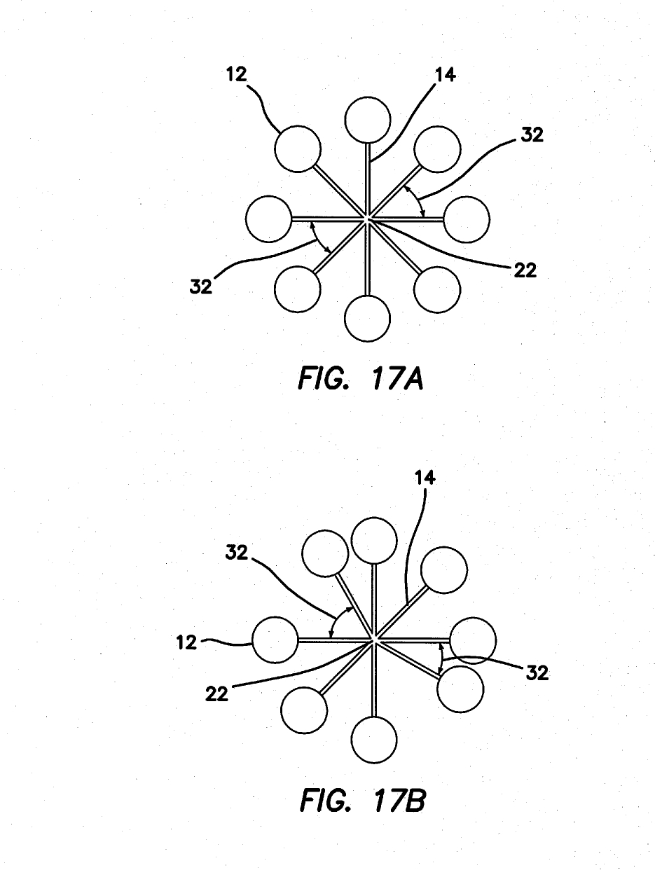

As shown in FIG. 1, above the first or male pallet 10 is a male mold flower 11, comprising interconnected male mold sections 12, about to be placed on the male pallet 10. The male pallet 10 can be designed to accommodate a plurality of male lens mold sections 12 at the same time. The male mold sections 12 on male mold flower 11 can be interconnected to one another through a gate structure. As shown, according to one example, the gate structure may comprise a central hub 22 and elongated runners 14. As illustrated in FIG. 1, each individual male lens mold section 12 can be connected to an elongated runner 14 and the runners 14 can join together at the central hub 22. This configuration (hub 22 and elongated runners 14) resembles a flower-like arrangement with the hub 22 as the bud and the runners 14 as the petals, the distal tips of the petals being the individual mold sections 12. As shown in FIG. 1, a sprue or rod 24 may be provided as part of the male mold flower 11, for example, attached or secured to hub 22, and located perpendicular to the plane in which the male mold sections 12 and elongated runners 14 are located. Sprue 24 may be useful in moving the male mold flower 11 in place on the male pallet 10. Also as illustrated in FIG. 1, there can be an angle 32 between any two runners 14. This angle 32 may be equal between any two adjacent runners for a symmetric arrangement or it may different. See FIG. 17 for a schematic representation of various examples, as discussed further herein.

The male mold flower 11 may have a different or alternate configuration relative to the male mold flower 11 shown in FIG. 1. A number of such different or alternate configurations are shown in FIGS. 1A, 1B and 1C, it being understood that other different or alternate configurations for the mold flower are possible and may be included within the scope of the present invention.

For example, as shown in FIG. 1A, alternate male mold flower 11A may be provided. Except as expressly described herein, male mold flower 11A may be structured and may function substantially similarly to male mold flower 11. The primary difference between male mold flower 11A and male mold flower 11 is that male mold flower 11A does not include a sprue, such as sprue 24 of male mold flower 11.

Another configuration of the male mold flower is shown in FIG. 1B. Except as expressly described herein, male mold flower lib, shown in FIG. 1B, may be structured and may function substantially similarly to male mold flower 11. The primary difference between male mold flower lib and male mold flow 11 is the configuration of the elongated runners 14b. In particular, as shown in FIG. 1B, each of the elongated runners 14b may be attached at one end to hub 22b. A sprue 24b may also be attached to hub 22b. The other end of each of the runners 14b may be formed into two branches 15. Each of the branches 15 may be attached to a different male mold section 12b.

In the configuration shown in FIG. 1B, the male mold flower lib includes 8 male mold sections 12b. This is the same number of male mold sections as is included in male mold flower 11. However, only 4 elongated runners 14b are directly attached to hub 22b, whereas 8 elongated runners 14 are directly attached to hub 22, as shown in FIG. 1.

FIG. 1C illustrates a further male mold flower 11c. Except as expressly described herein, male mold flower 11c may be structured and may function similarly to male mold flower 11b. The primary difference between male mold flower 11c and male mold flower 11b is that male mold flower 11c does not include a sprue, such as sprue 24b of male mold flower 11b.

As shown in FIG. 1, each male lens mold section 12 can be attached to a different first elongated runner 14, and the first or male pallet 10 can include a plurality of spaced apart first raised segments 26 forming a plurality of defined pathways for placement of each of the first elongated runners 14 in a different defined pathway to facilitate locating the male lens mold sections 12 on the first pallet 10. In this example, the raised segments 26 resemble raised tapered wedges. In another example, the first pallet 10 may comprise at least two raised segments 26 forming at least one defined pathway for placement of at least one first elongated runner 14 to facilitate locating at least one male mold section 12 on the first pallet 10. In yet another example, the first pallet may comprise two raised segments 26 forming a single defined pathway for placement of a single first elongated runner 14 to facilitate locating a single male mold section 12, or to facilitate locating a plurality of male mold sections 12 on the first pallet 10.

One or more openings 28 can be provided in the first pallet 10 to accommodate insertion of the male mold flower 11 therein. After the male lens mold sections 12 have been placed in the male pallet 10, the gate structure comprising the runners 14 and hub 22 may be disconnected from the male mold sections 12. In one example, the runners 14 and hub 22 may be removed through opening 28. For example, the runners 14 and hub 22 may be removed through opening 28 by allowing the runners 14 and hub 22 to drop through the opening 28, or by mechanically pushing the runners 14 and hub 22 through opening 28, or by using vacuum or suction to pull the runners and hub 22 through the opening 28. Optionally, as illustrated in FIG. 1, in one portion 36 of the male pallet 10, the opening 28 can be especially noticeable because one of the raised segments 26 may be missing. This portion 36 with the missing raised segment 26 on the male pallet 10 matches up with an area of webbing 30 between two elongated runners 14 such that the male mold flower 11 only fits on the male pallet in one particular way. This may be important as it can allow matching up specific male lens mold sections 12 formed in specific cavities of the injection molding system with specific female lens mold sections formed in specific cavities of the injection molding system. For example, different male lens mold sections 12 can be placed in different cavities 16 of the first pallet 10 to ensure that the correct male lens mold section is later combined with the correct female lens mold section, in order to be used to make contact lenses having different features, e.g., different optical properties.

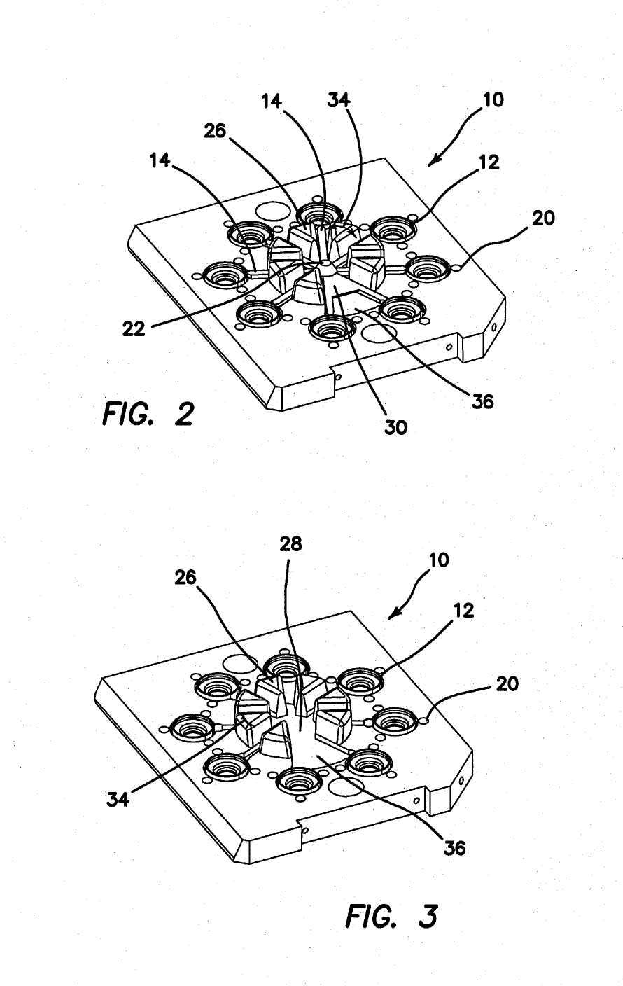

Referring now to FIG. 2, the male mold flower 11 comprising the gate structure 14, 22 interconnecting the various individual male lens mold sections 12 has been placed on, e.g., lowered onto, the male pallet 10. As compared to FIG. 1, the elongated runners 14 interconnecting the various male lens mold sections 12 are now between the raised segments on the male pallet 10 used to align and guide their placement. The webbed section 30 between two of the runners fits above the missing wedge portion 36. An angle 34 formed by the raised segments 26 (triangular wedges according to one example, as shown) substantially corresponds with an angle 32 formed between the elongated runners 14 (as shown in FIG. 1) in a manner such that each raised segment 26 fits between two elongated runners 14.

Referring now to FIG. 3, the gate structure 14, 22 interconnecting the various male lens mold sections 12 has been removed. Removal of the gate structure 14, 22 is optional. The male lens mold sections 12 are present on the male pallet 10 in their respective cavities 16 waiting to be picked up. Openings 28, 36 remain where the gate structure 14, 22 has been removed.

Optionally, the male pallet 10 may comprise multiple interconnected openings 28, 36 such that vacuum or suction can pull the gate structure 14, 22 through the openings 28, 36 substantially intact, without the runners 14 collapsing.

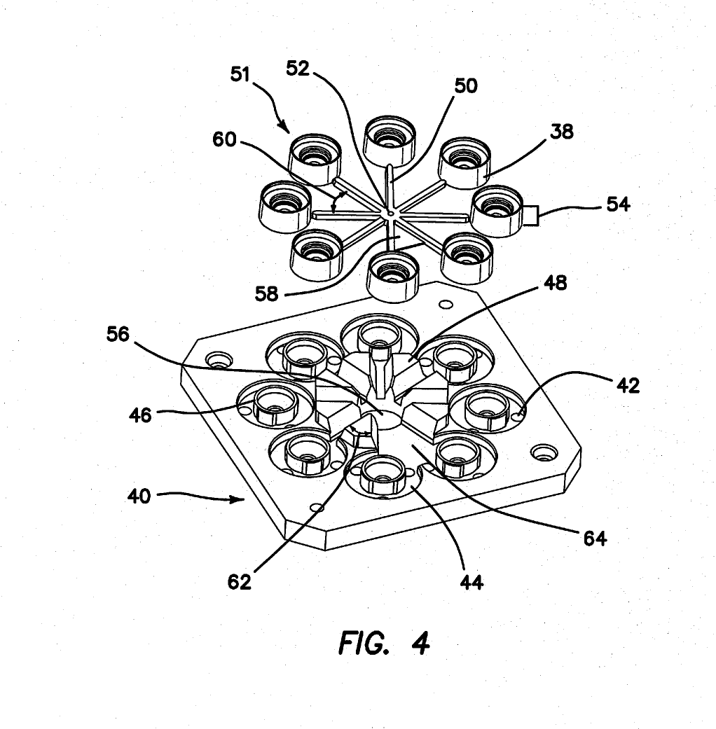

Referring now to FIG. 4, as shown in FIG. 4, the second or female pallet 40 can comprise a plurality of cavities 44, each cavity 44 sized and configured to receive a female lens mold section 38. The second pallet 40 comprises at least one cavity 44. In another example, the second pallet 40 can comprise a single cavity 44.

In the example illustrated in FIG. 4, a plurality of female lens mold sections 38 is provided. Each female lens mold section 38 can be attached to a different second elongated runner 50, and the second pallet 40 can include a plurality of spaced apart second raised segments 48 forming plurality of defined pathways for placement of each of the second elongated runners 50 in a different defined pathway to facilitate locating the female lens mold sections 38 on the second pallet 40. As in the example illustrated in FIG. 4, each second elongated runner 50 of each female lens mold section 38 may be secured to a central hub 52.

The runners 50 and hub 52 collectively form a gate structure. Other examples of the gate structure interconnecting the female lens mold sections to each other are also possible. Optionally, there can also be a sprue of the female mold flower similar to the sprue 24 of the male mold flower. It is not visible in the figures.

As shown in FIG. 4, female mold flower 51 can comprise a gate structure 50, 52 interconnecting a plurality of female lens mold sections 38. According to one example, as shown, the second raised segments 48 can take the form of substantially triangular wedges. The angle 62 formed by the raised segments 48 corresponds with an angle 60 between two adjacent elongated runners 50 in a manner such that each raised segment 48 fits between two elongated runners 50.

As with the first pallet 10, in another example, the second pallet 40 may comprise at least two raised segments 48 forming at least one defined pathway for placement of at least one elongated runner 50 to facilitate locating at least one female mold section 38 on the second pallet 40. In yet another example, the second pallet 40 may comprise two raised segments 48 forming a single defined pathway for placement of a single elongated runner 50 to facilitate locating a single female mold section 38, or to facilitate locating a plurality of female mold sections 38 on the second pallet 40.

As illustrated in FIG. 4, optionally, on one or more portions 64 of the female pallet 40 the raised segment 48 can be missing in order to accommodate webbing 58 between one or more sets of two adjacent elongated runners 50.

The second or female pallet 40 can optionally further comprise one or more through openings 56 (a singular opening 56 is shown in FIG. 4) through which the gate structure 50, 52 optionally can be removed. For example, the gate structure 50, may be removed through opening(s) 56 by allowing the runners 50 and hub 52 to drop through the opening(s) 56, or by mechanically pushing the runners 50 and hub 52 through opening(s) 56, or by using vacuum or suction to pull the runners 50 and hub 52 through the opening(s) 56.

Each cavity 44 on the female pallet 40 can optionally comprise a circumferential raised portion, or ridge, 46 sized and positioned to receive one female lens mold section 38. The circumferential raised portion 46 of each cavity 44 can be substantially adjacent a plurality of second alignment holes 42. The plurality of second holes 42 are effective to assist or facilitate the alignment of a female mold section 38 with a male mold section 12 in a cavity 44, as is discussed hereinafter.

As shown in FIG. 4, the raised portion or ridge 46 in the cavity 44 on the female pallet 40 can be inside the holes of the pallet. The holes 42 are also shown within the cavity 44, although examples where the holes 42 are outside the cavity 44 are also possible.

In one example (not shown) the raised portion or ridge 46 may be positioned outside the holes 42. In this example, a plurality of elongated alignment pins of a picking head may pass through holes in an alternate example of a female mold section (not shown), placed over the ridge, before entering the pin holes in the female pallet:

The circumferential raised portion or ridge 46 is effective to assist in alignment of the female mold section 38 in the cavity 44. In one example, each female lens mold section 38 can include an outside skirt 54 configured to fit over the circumferential raised portion or ridge 46.

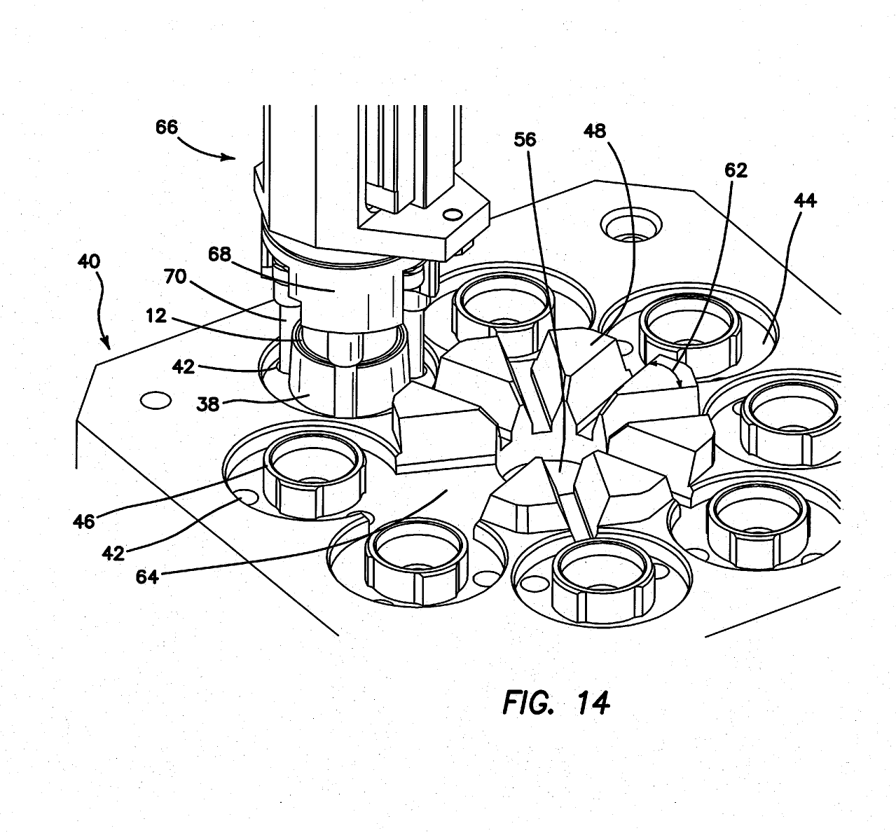

As shown in FIG. 4 and also FIG. 14, the female pallet 40 may comprise just one through opening 56 or central hole. Optionally, the gate structure 50, 52 can be detached from each of the female mold sections 38. In one example, the entire gate structure 50, 52 optionally can be removed through this one opening 56 or central hole. For example, the runners 50 and hub 52 may be removed through opening 56 by allowing the runners 50 and hub 52 to drop through the opening 56, or by mechanically pushing the runners 50 and hub 52 through opening 56, or by using vacuum or suction to pull the runners 50 and hub 52 through the opening 56. The gate structure 50, 52 can be configured to collapse inward on itself in order to fit through the opening 56.

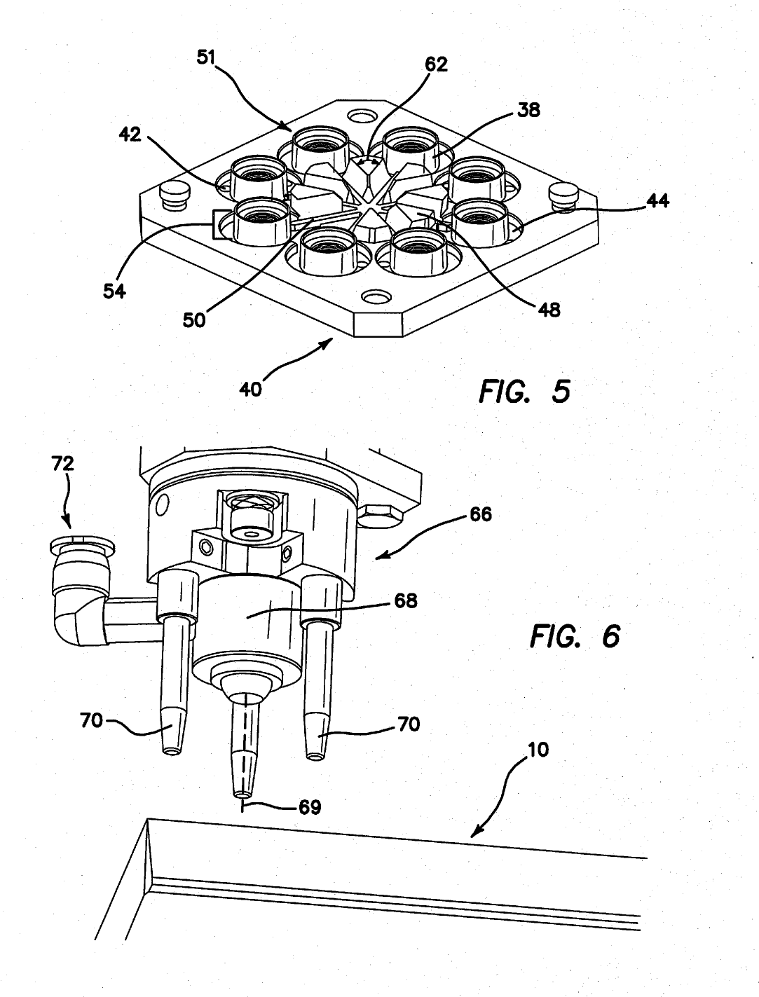

Referring now to FIG. 5, the female mold flower 51, comprising a gate structure 50, 52 interconnecting the plurality of female lens mold sections 38 has been placed on, e.g., lowered onto, the female pallet 40. The elongated runners 50 are now positioned within the defined pathways created by the raised segments 48.

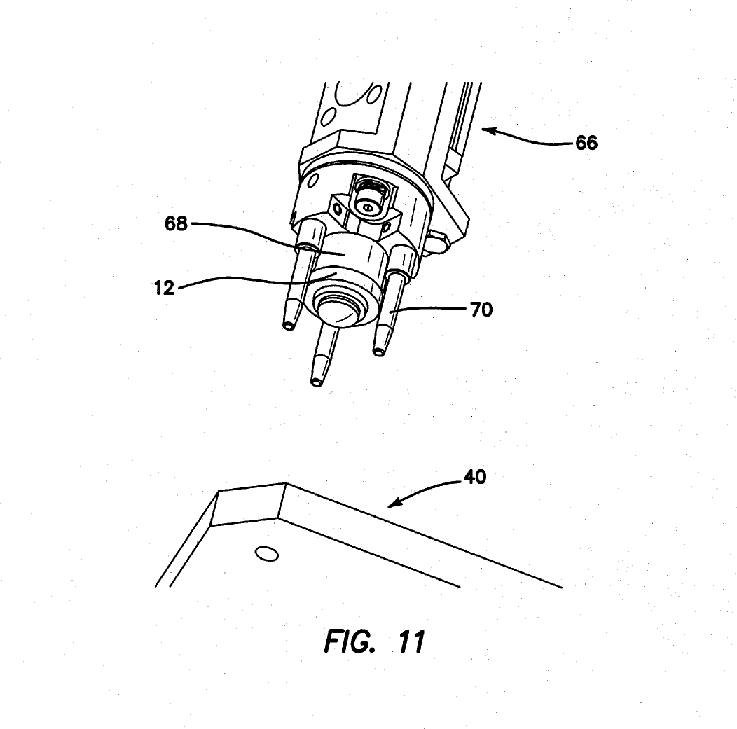

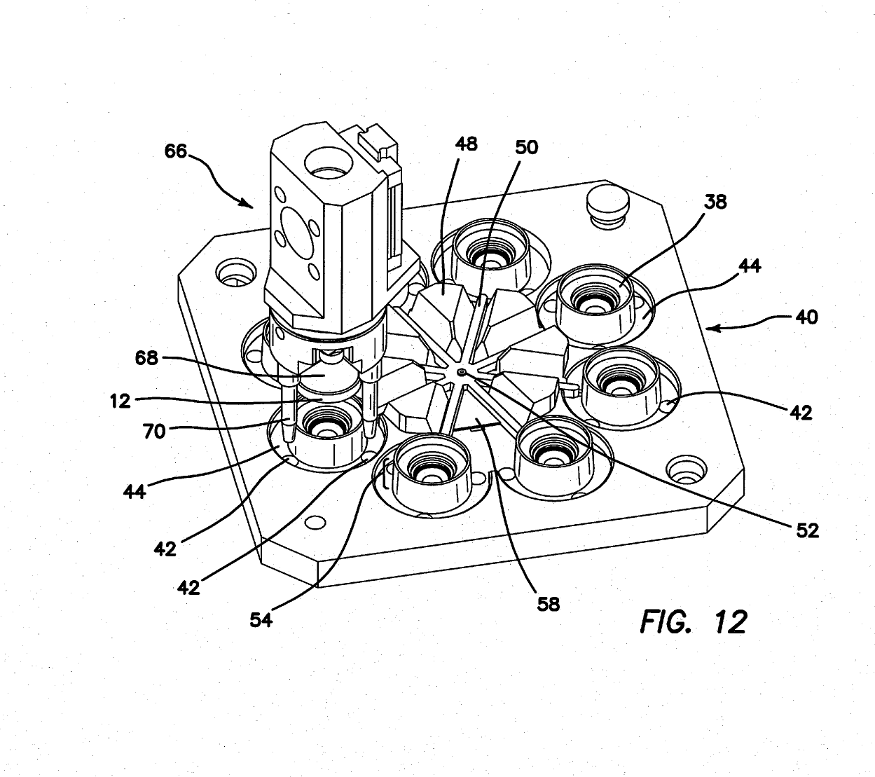

Referring now to FIG. 6, a picking head assembly 66 is provided in order to remove male lens mold sections 12 (see FIG. 7) from the first or male pallet 10, transfer them, and place them in contact with the female lens mold sections 38 carried by a second or female pallet 40 (not shown in FIG. 6). This picking head assembly 66 comprises a picking head 68, a plurality of alignment pins 70, and a vacuum or suction system 72, which can be of conventional design. The vacuum or suction system, shown schematically at 72, provides sufficient force to remove a male lens mold section 12 (see FIG. 7) from the male pallet 10 and to hold the male lens mold section 12 to the picking head 68 during transport of the male mold section to the female pallet 40 (see FIG. 11) and during lowering the male lens mold section 12 (see FIG. 7) into contact with the female lens mold section 38 (see FIG. 12) in the contact lens manufacturing process. The picking head assembly 66 may move substantially freely in a plane perpendicular to the longitudinal axis or central longitudinal axis 69 of the picking head 68. For example, if the picking head assembly 66 is lowered from directly over a horizontally situated male pallet 10, the picking head assembly may move substantially freely in a horizontal plane or in a plane perpendicular to the direction in which the picking head 68 is lowered as the alignment pins 70 are received in the holes 20 (see FIG. 7) on the male pallet 10.

Certain features of the picking head assembly 66 are shown in more detail in FIGS. 6A and 6B.

As shown in FIG. 6A, a shoulder screw 90 may be a fixedly secured to top housing 92. For example, the shoulder screw 90 can be fixedly secured to top housing 92 at one or more spaced apart locations 93, as shown in FIG. 6A.

As shown in FIGS. 6A and 6B, the shoulder screw 90 may extend downwardly into a hollow space 94 formed in connecting block 96. The downward most part 98 of the shoulder screw 90 is enlarged and has an upper surface 100 which supports spring 102. The other end of spring 102 is in contact with upper spring support 104, which is positioned on shoulder screw 90. A washer 106, for example, made of a polymeric material, such as polytetrafluoroethylene (Teflon), is deposed between upper spring support 104 and connecting block 96, for example, as a friction retaining device.

Connecting block 96 includes a through opening 108 through which shoulder screw 90 passes. Through opening 108 is larger in diameter than the relatively thin portion 110 of the shoulder screw 90 within the through opening so that a gap or space 109 between the walls of through opening 108 and the thin portion 110 exists. This gap 109 between the through opening 108 and thin portion 110 of the shoulder screw 90 may be effective in facilitating, or even allowing, substantially free movement of the picking head assembly 66 in a plane perpendicular to the longitudinal axis of the picking head 68.

As shown in FIG. 6A, connecting block 96 is also secured to picking head mount extension 112, which is the upper portion of picking head 68. The end 114 of extension 112 is located in a relatively large hollow space 116 defined by bearing housing 118.

Bearing housing 118 contains a number of spaced apart ball bearings 120 which rotate between top housing 92 and the top surface 122 of connecting block 96. The rotation of the ball bearings 120 may facilitate, or even allow, the picking head assembly 66 to move substantially freely in a plane perpendicular to the longitudinal axis of the picking head 68 as the alignment pins 70 are received in holes 20 of the male pallet 10.

The spring 102 may create a preload on the connecting block 96, may prevent undesired movement of the picking head assembly 66, and may be effective in maintaining or stabilizing the position of the picking head assembly 68.

FIG. 6B shows many of the components of picking head assembly 66 described above with reference to FIG. 6A in a more complete illustration of the picking head assembly.

With reference to FIG. 6, the alignment pins 70 of the picking head assembly are designed to fit into first alignment holes 20 on the male pallet 10 and the second alignment holes 42 on the female pallet 40. The pins 70 are placed into holes 20 on the male pallet 10 in order to align, for example, substantially precisely align, the picking head 68 with a male lens mold section 12 before removing the mold section 12 from the male pallet 10.

The pins 70 are also placed into second alignment holes 42 on the female pallet 40 in order to align, for example, substantially precisely align the picking head 68 carrying a male lens mold section 12 with a female lens mold section 38 prior to lowering the male lens mold section 12 into contact with a female lens mold section 38 in the process of manufacturing a contact lens.

Referring now to FIG. 7, the picking head 68 of the picking head assembly 66 approaches the male mold section 12, for example, by being lowered toward the male mold section. Then, as the picking head 68 is further moved toward the male mold section 12, the pins 70 are received deeper into the holes 20. At this point, with the pins 70 inserted into the pallet 10, the picking head 68 is aligned, for example, precisely aligned, with the male mold section 12. The picking head 68 can then be further lowered until it engages or contacts the male lens mold section 12. Thus, the picking head 68 is aligned with the male mold section 12 before the picking head contacts the male mold section.

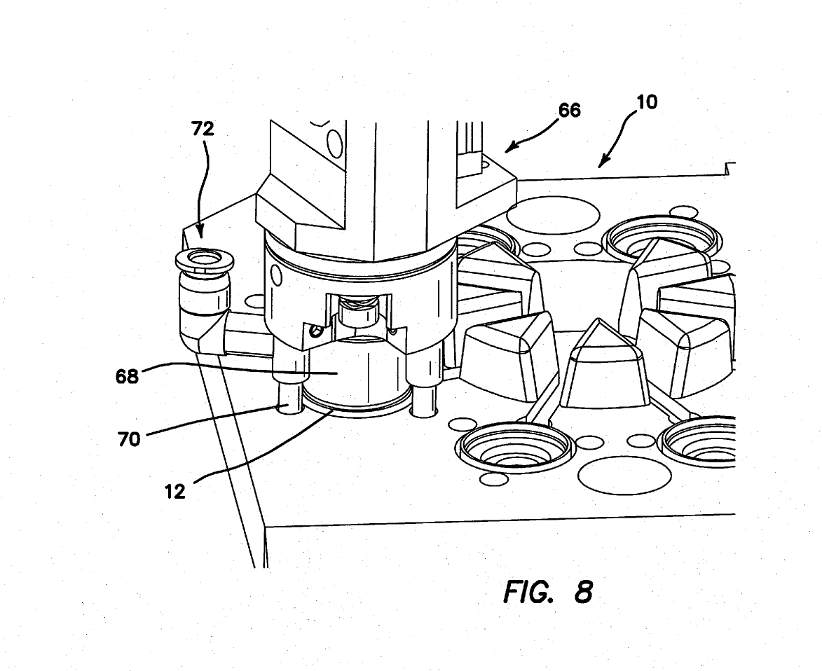

Referring now to FIG. 8, the picking head 68 has been moved, e.g., lowered, to engage the male lens mold section 12. Optionally, at this point, vacuum or suction can be applied to the picking head 68 through the vacuum or suction port 72 in order to engage the male mold section 12

FIG. 9 is a cross-sectional view of the picking head engaged with the male lens mold section 12. With the picking head assembly 66 fully engaged with the male pallet 10 and the male lens mold section 12, the optical surface 74 of the male lens mold section 12 is not in contact with any surface of the male pallet 10 or the pick head assembly 66, as the male mold is contained within a cavity 16 of the male pallet 10. The alignment pins 70 are fully inserted within the pin holes 20. Optionally, as illustrated in the example illustrated in FIG. 9, the shape of the face 75 of the picking head 68 may substantially correspond to a substantial portion of the inner, wall, shape of the male lens mold section 12, including flanged regions, such as inner flange region 76, to facilitate the picking head 68 being able to remove the male lens mold section 12 from the male pallet 10 using vacuum or suction 72, which is applied to the male mold section 12 through a hole in picking head 68.

Referring now to FIG. 10, the picking head 68 portion of the picking head assembly 66, as shown, has successfully picked up or removed the male lens mold section 12 from the male pallet 10, has moved away from the male pallet 10 and is waiting to mate the male mold section with a corresponding female lens mold section 38 on a female pallet 40, in the process of manufacturing a contact lens. In one example, the male lens mold section 12 can be mated with a female lens mold section 38 by the picking head 68 carrying the male mold section over to the female pallet 40. In another example, the male lens mold section 12 can be mated with the female lens mold section 38 by the picking head 68 lifting and then lowering the male lens mold section as the female pallet 40 is substituted for the male pallet 10. During the processes of either example, the male lens mold section 12 can be held to the picking head 68 through vacuum or suction 72. Optionally, a polymerizable composition can be placed into the female mold member 38 prior to aligning the male mold member 12 and the female mold member 38. Alternatively, the female mold member 38 and the male mold member 12 can be aligned, and then the male mold member 12 can subsequently be removed, the polymerizable composition can be added to the female mold member 38, and the male mold member 12 can be re-aligned with the female mold member 38.

Referring now to FIG. 11, the picking head 68 is shown moving the male lens mold section 12 to the female pallet 40. The vertically elongated alignment pins 70 of the picking head assembly 66 extend distally further than the picking head 68 with attached male lens mold section 12.

Referring now to FIG. 12, as the male lens mold section 12 carried by or held to the picking head 68 approaches a female lens mold section 38 on female pallet 40, the alignment process starts when the two lens mold sections are still far apart. In one example, optionally; the alignment process can begin as the alignment pins 70 of the picking head assembly 66 come in contact with the outer surface of the outside skirt 54 of the female lens mold section 38. However, it is not necessary for the pins 70 to contact the outside skirt 54 during the alignment process. In other words, alignment of the male lens mold section 12 and the female lens mold section 38 can be achieved by the alignment pins 70 entering the pin holes 42, by the pins 70 contacting an outside portion of the female lens mold section 38, or by both. The pins 70 can then move downward along the outer surface of the female lens mold section 38, such as, for example, an outside skirt 54, into the cavity 44 portion of the female pallet 40 and down into the holes 42 on the female pallet 40.

Optionally, as shown in FIGS. 12 and 13, the plurality of pins 70 may be positioned in pin holes 42 inside the recessed cavity 44, around the outside of the circumferential raised portion 46 over which the female lens mold section 38 with outer skirt 54 and optical surface 78 fits. As can be seen in FIG. 12, during the alignment process, no surface comes into contact with the optical surface 78 of the female lens mold section 38, although the polymerizable composition may be in contact with the optical surface 78 of the female lens mold section 38 during the alignment process.

Referring further to FIG. 13, a cross-sectional view is provided of the pins 70 of the picking head assembly 66 lowered into the holes 42 in the female pallet 40. The male lens mold section 12 is aligned, for example, precisely aligned, above the female lens mold section 38 prior to being put in contact with the female mold section. The picking head assembly 66 moves substantially freely in a horizontal plane or in a plane perpendicular to the longitudinal axis of the picking head 68 or in a plane perpendicular to the direction in which the picking head is lowered.

As illustrated in FIG. 12 and FIG. 13, the elongated runners 50 (or an alternative gate structure) may still be attached to the female mold section 38 and present on the second pallet 40 when the alignment process begins. Alternatively, in other examples (not shown) the runners 50 (or other gate structure) can be detached before the alignment process begins.

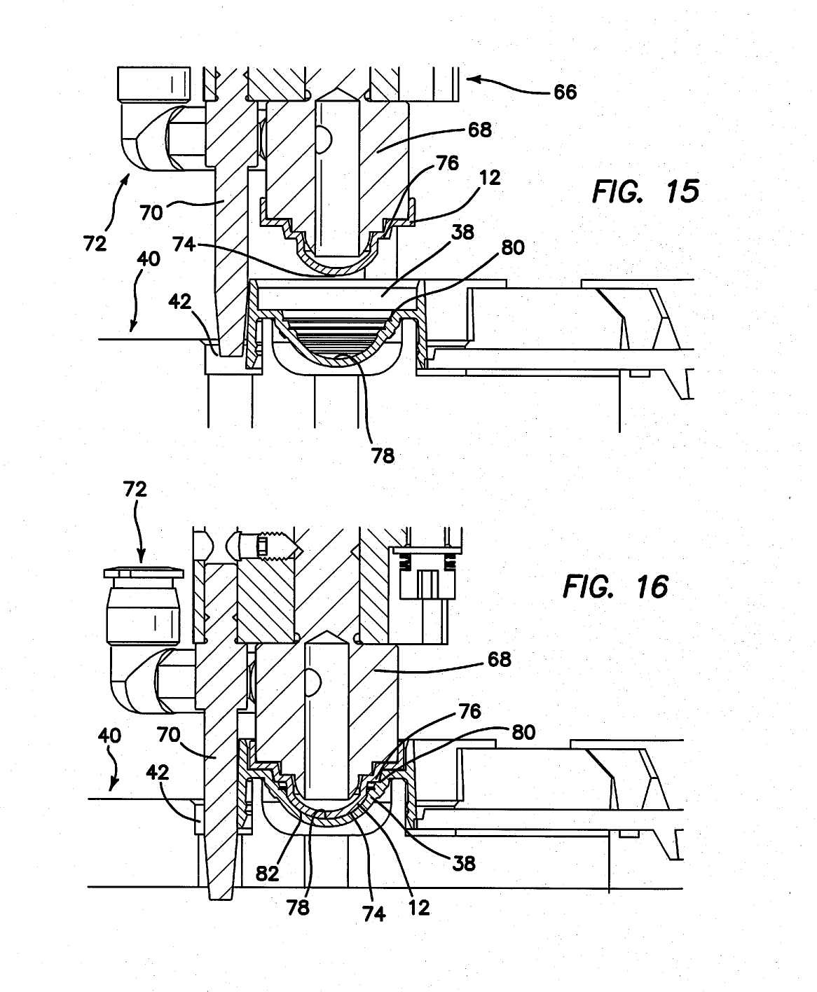

Referring now to FIG. 14, the system for manufacturing a contact lens is shown with alignment, for example, substantially precision alignment between the male mold section 12 and female mold section 38 completed. The pins 70 have been lowered completely into holes 42 on the female pallet 40 and the male lens mold section 12 carried by the picking head 68 has been lowered into contact with the female lens mold section 38 on the female pallet 40. Even in this configuration, the optical surface 74 of the male lens mold section 12 does not contact the optical surface 78 of the female lens mold section 38, although the polymerizable composition may be in contact with both the optical surface 74 of the male lens mold section 12 and the optical surface 78 of the female lens mold section 38 when the mold sections are in alignment. (See cross-sectional views in FIG. 15 and FIG. 16.)

Referring now to FIG. 15, a cross-sectional view is provided with alignment, for example, substantially precision alignment completed and the pins 70 of the picking head assembly 66 in the holes 42 on the female pallet 40. The picking head 68 is shown above the female pallet 40, as it is during the alignment process. Optionally, the picking head assembly 66 can place the male lens mold section 12 in contact with the female lens mold section 38, for example, by placing in contact the flanged region 76 of the male mold section and the flanged region 80 of the female mold section. In one example, after placing the male mold section 12 and the female mold section 38 in alignment, the picking head assembly 66 can then pick up and move the male lens mold section 12 above the female lens mold section 38 to create a space between the male lens mold section 12 the picking head carries and the female lens mold section 38 on the female pallet 40, for example to permit dosing of polymerizable composition into the female lens mold section 38. After creating a space between the female lens mold section 38 and the male lens mold section 12, the pick up head assembly 66 can then place the male mold section 12 and the female mold section 38 in alignment again.

Referring now to FIG. 16, a cross-sectional view is provided after the polymerizable composition dosing process is complete. The picking head 68 has been moved down, placing the male lens mold section 12 in contact with the female lens mold section 38. The optical surface of the male lens mold section 74 does not contact the optical surface of the female lens mold section 78. The polymerizable composition is located in the lens-shaped cavity 82 formed between the optical surface of the female mold section 78 and the optical surface of the male mold section 74 when the female mold section 38 and the male mold section 12 are placed in alignment, forming a mold assembly.

Optionally, once the male lens mold section 12 is in contact with the female lens mold section 38, the picking head 68 or a separate device (not shown) can apply a downward force to the back to the male lens mold section 12 sufficient to engage an interference fit between the female lens mold section 38 and the lens mold section 12. FIG. 16 shows a cross-sectional view after the picking head 68 has engaged the interference fit between the male lens mold section 12 and the female lens mold section 38. Note that as compared to FIG. 15, the alignment pins 70 of the picking head assembly 66 have been lowered deeper into the holes 42 on the female pallet 40. Contact between the male and female mold sections is only between the flanged region 76 of the male lens mold section 12 and the flanged region 80 of the female lens mold section 38, which form the interference fit between the male and female mold sections.

In another example, optionally, the male lens mold section 12 can be affixed to the female lens mold section 38, for example by applying a heat stake to melt a portion of each mold section and weld the mold sections together in a plurality of locations. The heat stake can be incorporated into the picking head assembly 66, or can be a separate device. In yet another example, optionally an adhesive can be applied between the female lens mold section 38 and the male lens mold section 12 in order to affix the mold sections to each other.

Referring now to FIG. 17, schematic representations are shown of two of many possible arrangements of the mold flowers comprising a plurality of lens mold sections interconnected to each other through elongated runners joined to a central hub. Although reference numerals corresponding to the male lens mold sections and associated elements are provided, these schematic representations also represent possible arrangements for the female lens mold sections. In FIG. 17A, all angles 32 between any two adjacent elongated runners 14 are equal resulting in a symmetric arrangement. In FIG. 17B, all angles 32 between any two adjacent elongated runners 14 are not equal and an asymmetric arrangement is provided. However, an arrangement could also be provided in which some angles are equal and some angles are not equal.

De-gating refers to the process of detaching the runners 14, 50 from the molds 12, 38 and removing the runner and hub network (or other gate structure) such that the molds are alone and isolated from each other on the pallet. In one example, de-gating may involve detaching the runner and hub network 14, 22 or 50, 52 (or other gate structure) from the molds 12, 38 and then passing it through one or more openings 28 or 56 in the pallet 10, 40. For example, the runner and hub network 14, 22 or 50, 52 may be removed through opening 28 or 56 by allowing the runner and hub network 14, 22 or 50, 52 to drop through the opening(s) 28 or 56 or by mechanically pushing the runner and hub network 14, 22 or 50, 52 through opening(s) 28 or 56, or by using vacuum or suction to pull the runner and hub network 14, 22 or 50, 52 through the opening(s) 28 or 564

This de-gating process may be performed before or after the picking head 68 is aligned above the mold 12, 38 and before or after the picking head 68 is lowered to the mold, such as for picking up a male mold 12 or bringing the male mold into contact with the female mold 38.

In one example, de-gating, in the form of detaching the first elongated runners 14 from the male lens mold sections 12, may occur prior to the step of placing the picking head assembly 66 into engagement with the first pallet 10 carrying the male lens mold sections 12.

In one example, de-gating, in the form of detaching the second elongated runners 50 from the female lens mold sections 38, may occur prior to the step of moving the picking head assembly 66 (and male lens mold section 12 carried by it) into engagement with the female pallet 40.

In one example, the first (male) pallet 10, in addition to its cavities 16 with rims 18 (for fitting male mold) and pin holes 20 adjacent thereto, may also comprise a plurality of spaced apart first raised segments 26 forming plurality of defined pathways for placement of each of the first elongated runners 14 in a different defined pathway to facilitate locating the male lens mold sections 12 on the first pallet 10.

In one example, the first pallet 10 may comprise openings 28 to allow the elongated runners 14 to pass through the pallet 10 when the elongated runners 14 are detached from the male mold sections 12.

Similarly, the second (female) pallet 40, in addition to its cavities 44 with ridges 46 (for fitting female mold 30) and pin holes 42 adjacent thereto, may also comprise a plurality of spaced apart second raised segments 48 forming a plurality of defined pathways for placement of each of the second elongated runners 50 in a different defined pathway to facilitate locating the female lens mold sections 38 on the second pallet 40.

In one example, the second pallet 40 may comprise one or more openings 56 to allow the second (female) elongated runners 50 to pass through the pallet 40 when the elongated runners are detached from the female mold sections 38.

The flower-like arrangement of the individual mold sections 12, 38 around a central hub 22, 52 may be either symmetric (as shown) or asymmetric. Accordingly, the system of cavities 16, 44 and plurality of spaced apart raised segments 26, 48 forming a plurality of defined pathways (for runners 14, 50) on the pallets 10, 40 may be correspondingly symmetric (as shown in all drawings except FIG. 17B) or asymmetric (see FIG. 17B) such that the flower-like arrangement of mold sections 12, 38 and/or gate structure (hub 22, 52, runners 14, 50) matches up to fit on the pallet 10, 40 appropriately.

As shown in FIG. 17A, in a symmetric arrangement, the flower-like arrangement of mold sections 12 is such that each mold section 12 has another mold section 12 directly opposite it. In other words, all opposite angles 32 formed by the runners 14 interconnecting the mold sections are equal. To accommodate this, all angles 34 (see FIG. 2 and FIG. 3) formed by any two opposite wedge-shaped raised segments 26 on the pallet 10 (to assist in alignment of gate structure onto pallet) are equal.

However, there are still different variations of a symmetric arrangement. In one example, according to a first symmetric arrangement (as shown in all drawings except FIG. 17B), the presence of webbing 30, 58 between two of the runners 14, 50 makes it so that the flower can only be placed into the pallet 10, 40 in one position, as the pallet is made to accommodate the presence of the webbing 30, 58 by having only one missing wedge-shaped raised segment 36, 64.

In another example, according to a second symmetric arrangement, the flower system could not have the webbing 30, and the pallet 10, 40 could have all wedges 26, 48 (no missing wedge 36, 64), such that it would be possible to rotate the flower and have the mold sections 12, 38 still fit within the pallet 10, 40, providing several possible positions (distinguishable only to the extent that the properties of the individual molds or chemical compositions placed into the molds are different). That is, rotating the hub 22, 52 would cause different mold sections 12, 38 to fit into different mold cavities 16, 44 on the pallet 10, 40.

In one example, in an asymmetric arrangement (as shown in FIG. 17B), the flower-like arrangement of mold sections 12 fits on the correspondingly asymmetric pallet in only one way, and rotating the hub 22 away from the singular aligned orientation would cause the mold sections 12 not to fit into the cavities 16 on the pallet.

In an asymmetrical flower, at least two of the opposite angles 32 (formed by the runners 14) are different, and thus the shapes of the Wedge-shaped raised segments 26 on the pallet 10 are different for at least two opposite segments, and no matter how the flower is rotated, the mold sections will only fit in the pallet 10 in one position.

By precisely controlling the vertical travel distance of the picking head assembly 66 that delivers the male mold 12 to the female mold 38, perfect or near perfect alignment is achieved without the optical surfaces of the male and female mold sections coming into contact. Additionally, when a closing force is applied to the mold sections, the closing force can be closely monitored.

In one example, the step of closing the aligned male and female lens mold sections together may involve monitoring a force required to close the aligned male and female lens mold sections, determining whether or not the force required to close the male and female lens mold sections is within a specified range, and if the force required is outside the specified range, rejecting the aligned male and female lens mold sections and removing the mold sections from manufacturing line.

Alignment can be performed before or after monomer dosing onto the female mold 38. In one example, according to a first alternative, alignment is performed before monomer dosing. This involves aligning the molds, separating the molds for monomer dosing, and then placing the molds in contact again. In one example, according to a second alternative, alignment is performed after monomer dosing. This involves dosing monomer onto the female mold 38 (which may, but need not, be solitary or isolated from the male mold 12) and then aligning the male and female molds and subsequently placing them in contact.

In the first alternative, alignment is immediately followed by dosing monomer. In the second alternative, alignment is immediately followed by placing the molds in contact.

In one example, after alignment is achieved, the male and female lens molds can be brought into contact, and their respective flanged regions 76, 80 can be engaged with one another. Closing the male mold section 12 and the female mold section 38 optionally can comprise applying force to the male mold section 12 to engage an interference fit between the male mold section 12 and the female mold section 38. The closing force can be applied by the picking head 68 pressing down on the male mold section 12. In this example, the solid picking head 68 head itself can physically press down on the male mold section 12 to engage the interference fit between the male mold section 12 and the female mold section 38. The pressing force can be monitored, and it is possible to accept or reject a mold assembly based on the force required to engage the interference fit. In this example, the vacuum source 72 can be operatively coupled to the picking head 68 operable to secure the male lens mold section 12 to the picking head 68.

Following closing to form an interference fit, the male mold section 12 may be placed into actual contact with the female mold section 38. Even during this stage of actual contact between the male and female mold sections, contact of the optical surfaces 74, 78 of the molds may be avoided. Any contact that occurs between the molds 12, 38 may be at the edges or flanges 76, 80 of the molds while leaving their optical surfaces 74, 78 preserved and protected.

Subsequently, the male mold section 12 can be raised away from and out of contact with the female mold section 38. Monomer may then be dosed onto the female lens mold 38.

After the male lens mold section 12 has been placed in contact with, and affixed to the female lens mold section 38 forming a closed mold assembly, the closed mold assembly can be transferred to a tray using the vacuum 72 head. For example, using the vacuum or suction 72 to hold the male lens mold section 12 to the picking head 68 of the picking head assembly 66, the picking head assembly 66 can be used to move the closed mold assembly to a tray.

In one example, when the male lens mold section 12 and the female lens mold section 38 of the closed mold assembly have both been de-gated from the runner and hub network of the male mold flower 14, 22 and the runner and hub network of the female mold flower 50, 52, the closed mold assemblies can be transferred to a tray individually. In another example, when either the male lens mold section 12 and the female lens mold section 38 have not been de-gated from either the runner and hub network of the male mold flower 14, 22 or the runner and hub network of the female mold flower 50, 52, i.e., when either or both the male mold section and the female mold section of a closed mold assembly remain attached to their respective runner and hub networks, all of the closed mold assemblies attached to a runner and hub network 14, 22 or 50, 52 can be transferred to a tray at the same time.

In one example, when the male and female lens mold sections are in contact, a form of energy may be applied to secure the male mold section 12 and the female mold section 38. For example, the lens mold, sections may be welded together by heat stake, laser, ultrasound, etc.

In one example, a form of energy may be applied to secure the male mold section 12 and the female mold section 38 before the vacuum 72 head (carrying or holding the male lens mold 12 to the picking assembly 66) disengages from the male mold section 12.

In one example, the energy may be applied before the plurality of spaced apart alignment pins 70 on the picking head assembly 66 are disengaged from the second (female) pallet 40.

In one example, following the dosing of the polymerizable composition into the lens-shaped cavity and alignment of the female mold section 38 and the male mold section 12 to form the mold assembly, the mold assembly can be exposed to a form of energy, such as, for example, thermal radiation, UV light, and the like; in order to cause polymerization of the polymerizable composition, thus forming a polymeric lens body within the lens-shaped cavity of the mold assembly.

### Materials

In addition to what is explicitly recited herein, suitable materials and compositions for the polymerizable composition and the polymeric material may be found in the following application, publications and patents each of which is incorporated in its entirety herein by reference: U.S. patent application Ser. No. 12/894,941, filed Sep. 30, 2010, entitled “Silicone hydrogel contact lenses and methods of making silicone hydrogel contact lenses”; U.S. Patent Application Publication No. 20060063852; U.S. Patent Application Publication No. 20070066706; U.S. Pat. No. 7,320,587; and U.S. Pat. No. 7,785,092.

In one example, either or both of the male and female lens mold sections may comprise one or more polymeric materials. Suitable polymeric materials for the mold sections include, but are not limited to, the following compositions and combinations thereof: thermoplastic materials, for example, such as polystyrene or polypropylene, and the like.

In one example, each of the male and female lens mold sections may comprise an injection molded thermoplastic polymeric material. Suitable thermoplastic materials include those in which the flow characteristics of the fluid thermoplastic polymeric material used to form the mold sections advantageously have an appropriate balance of high fluidity during introduction of the fluid thermoplastic polymeric material into a mold cavity (used to form the mold) and rapid cooling and/or solidification of the thermoplastic material once the cavity has been filled.

The thermoplastic material may be a thermoplastic polymeric material, for example, selected from any suitable such material or mixtures of such materials. For example, and without limitation, the thermoplastic polymeric material may comprise a polymer such as polyolefins, e.g., polypropylene, polyethylene, and the like, poly ethylene vinyl alcohol (EVOH), polyamides, poly oxy methylene, poly ethylene terephthalate, cyclic olefin co-polymers, polystyrene, polyvinyl chloride, copolymers of styrene with acrylonitrile and/or butadiene, acrylates, for example, poly methyl methacrylate, and the like, polyacrylonitrile, polycarbonate, polyesters, poly(4-methylpentene-1), and the like and mixtures thereof.

In one example, the polymeric material of the mold section can comprise a non-polar thermoplastic material, such as, for example, polystyrene or polypropylene. In another example, the polymeric material can comprise a polar thermoplastic material, such as, for example, polybutylene terephthalate, or an ethylene vinyl alcohol polymer, or a vinyl alcohol copolymer other than an ethylene vinyl alcohol polymer. In yet another example, the polymeric material can comprise a mixture of a polar thermoplastic material and a non-polar thermoplastic material.

In one example, the mold section may comprise a ethylene vinyl alcohol polymer (EVOH). For example, examples of the present mold sections, including the illustrated examples, can be made from an EVOH based resin publicly available under the tradename of SOARLITE™ S by Nippon Gohsei, Ltd. (Osaka, Japan). Various grades of EVOH with ethylene copolymerization ratio of about 25-50% by mole can be used in the present invention. Ethylene vinyl alcohol polymers are particularly useful, for example, from the viewpoint of ease of molding, providing a dimensionally stable mold and giving stable water wettability to the molded lens. “Soarlite” is an example of an ethylene-vinyl alcohol copolymer resin product.

In another example, the mold section may comprise a vinyl alcohol copolymer available under the tradename of G-POLYMER™ by Nippon Gohsei, Ltd. (Japan).

In yet another example, the mold section may comprise a form of polybutylene terephthalate (PBT).

Other suitable molding materials include polypropylene, polyethylene, polyamides, poly oxy methylene, poly ethylene terephthalates, cyclic olefin co-polymers, polystyrene, polyvinyl chloride, copolymers of styrene with acrylonitrile and/or butadiene, acrylates such as poly methyl methacrylate, polyacrylonitrile, polycarbonate, polyamides, polyesters, poly(4-methylpentene-1), and the like, and mixtures thereof.

Very useful mold materials are insoluble to a polymerizable composition and have contact angles to water at least at the part for forming one lens surface, not higher than about 90 degrees, by the sessile drop method. In one example, the contact angles may be about 65 degrees to about 80 degrees, by the sessile drop method. A contact lens formed using a mold material having surface contact angle smaller than 80 degrees shows particularly superior water wettability and stable performance in lipid deposition and the like. A mold material having surface contact angle smaller than 65 degrees is not advantageous because of difficulty in separating from the mold after polymerization, resulting in minute surface damage or fractures at an edge part of lens. A mold material soluble to monomer compositions is also difficult to use because of difficulty in separating the lens as well as rough lens surfaces and low transparency.

In the process of manufacturing a contact lens according to the present invention, a polymerizable composition may be placed on the female lens mold section. As the male lens mold section is moved into alignment with the female lens mold section and closes in upon it the polymerizable composition is positioned between the male lens mold section and the female lens mold section.

The polymerizable composition comprises at least one monomer. In one example, the polymerizable composition comprises at least one of a silicon-containing monomer.

Each of every patent application, patent application publication and patent identified herein is incorporated in its entirety herein by reference.

While the present invention has been described with respect to various specific examples and embodiments, it is to be understood that the invention is not limited thereto and that it can be variously practiced within the scope of the following claims.

1. A method for manufacturing a contact lens, the method comprising:
placing a picking head assembly comprising a picking head and a plurality of spaced apart alignment pins into engagement with a first pallet carrying a male lens mold section having a first optical surface and having a plurality of first holes sized and positioned to receive the plurality of spaced apart alignment pins, the placing being effective so that the picking head comes into alignment with the male lens mold section as the plurality of spaced apart alignment pins are received by the plurality of first holes and before the picking head contacts the male lens mold section;
securing the male lens mold section to the picking head;
separating the picking head assembly and the male lens mold section from the first pallet;
moving the separated picking head assembly and the male lens mold section into engagement with a second pallet carrying a female lens mold section having a second optical surface and having a plurality of second holes sized and positioned to receive the plurality of spaced apart alignment pins, the moving being effective so that the male lens mold section comes into alignment with the female lens mold section as the plurality of spaced apart alignment pins are received in the plurality of second holes and before the male lens mold section contacts the female lens mold section; and
placing the aligned male and female lens mold sections in contact with each other.

2. The method of claim 1 which further comprises:
providing a polymerizable composition between the aligned male and female lens mold sections, forming a mold assembly; and
reacting the polymerizable composition to form a polymeric contact lens body.

3. The method of claim 1, wherein the picking head has a longitudinal axis and the picking head assembly moves substantially freely in a plane perpendicular to the longitudinal axis of the picking head.

4. The method of claim 3, wherein the movement of the picking head assembly substantially freely in a plane perpendicular to the longitudinal axis of the picking head facilitates at least one of the coming into alignment of the picking head with the male lens mold section and the coming into alignment of the male lens mold section and the female lens mold section.

5. The method of claim 1, wherein the first pallet, the second pallet and the picking head assembly are configured so that the first optical surface of the male lens mold section does not come into contact with any surface when the first pallet is carrying the male lens mold section, when the male lens mold section is secured to the picking head, during the separating step, during the moving step and during the closing step.

6. The method of claim 1, wherein the first pallet has a first cavity sized and positioned to receive the male lens mold section, and a circumferential rim recessed within the cavity, the rim being substantially adjacent the plurality of first holes sized and positioned to receive the plurality of spaced apart alignment pins, and the rim being effective to assist in alignment of the male lens mold section in the cavity without contacting the first optical surface of the male lens mold section.

7. The method of claim 1, wherein the second pallet has a second cavity sized and positioned to receive the female lens mold section, and a circumferential raised portion within the cavity, the raised portion being effective to assist in aligning the female lens mold section in the cavity with the male lens mold section, without said male lens mold section contacting the second optical surface of the female lens mold section.

8. The method of claim 2, wherein the providing step comprises placing the polymerizable composition on the female lens mold section at at least one of the following times: before the moving step, during the moving step, and after the moving step.

9. The method of claim 8, wherein the polymerizable composition is placed on the female lens mold section before the moving step.

10. The method of claim 8, wherein the polymerizable composition is placed on the female lens mold section after the moving step.

11. The method of claim 1, wherein the female lens mold section includes a mold outside skirt, and the moving step is effective to contact the plurality of spaced apart alignment pins with the mold outside skirt prior to the plurality of spaced apart alignment pins being received by the plurality of second holes.

12. The method of claim 1, wherein the first pallet carries a plurality of male lens mold sections, and the second pallet holds a plurality of female lens mold sections.

13. (canceled)

14. The method of claim 1, wherein the moving step is effective so that the male lens mold section comes into alignment with the female lens mold section without the first optical surface contacting the second optical surface.

15. The method of claim 1, wherein the first pallet includes at least one first structural feature to facilitate the picking head coming into alignment with the male lens mold section.

16. The method of claim 1, wherein the male lens mold section is attached to a first elongated runner and the first pallet includes a plurality of spaced apart first raised segments forming a defined pathway for placement of the first elongated runner to facilitate locating the male lens mold section on the first pallet.

17. The method of claim 16, wherein the first pallet comprises an opening to allow the elongated runner to pass through the first pallet when the elongated runner is detached from the male lens mold section.

18. The method of claim 1, wherein the second pallet includes at least one second structural feature to facilitate the male lens mold section coming into alignment with the female lens mold section.

19. A system for manufacturing a contact lens, the system comprising:
a picking head assembly comprising a picking head and plurality of spaced apart alignment pins;
a first pallet carrying a male lens mold section and having a plurality of first holes sized and positioned to receive the plurality of spaced apart alignment pins;
a vacuum source operatively coupled to the picking head and being operable to secure the male lens mold section to the picking head; and
a second pallet carrying a female lens mold section and having a plurality of second holes sized and positioned to receive the plurality of spaced apart alignment pins, the second pallet having a second cavity sized and positioned to receive the female lens mold section, and a circumferential raised portion within the second cavity, the raised portion being effective to assist in aligning the female lens mold section in the second cavity with the male lens mold section without the male lens mold section contacting a second optical surface of the female lens mold section, wherein the picking head assembly and secured male lens mold section are movable into engagement with the second pallet so that the male lens mold section comes into alignment with the female lens mold section as the plurality of spaced apart alignment pins are received in plurality of second holes.

20. The system of claim 19, wherein the picking head has a longitudinal axis and the picking head assembly is substantially freely movable in a plane perpendicular to the longitudinal axis of the picking head.

21. The system of claim 19, wherein the first pallet has a first cavity sized and positioned to receive the male lens mold section, and a circumferential rim recessed within the cavity, the rim being substantially adjacent the plurality of first holes sized and positioned to receive the plurality of, spaced apart alignment pins, and the rim being effective to assist in alignment of the male lens mold section in the cavity without contacting the first optical surface of the male lens mold section.
